(19) United States
(12) Patent Application Publication
(10) Pub. No.: US 2016/0332901 A1
(43) Pub. Date: Nov. 17, 2016

(54) BIOFILM FILTER DEVICE, DESALINATION SYSTEM, AND BIOFILM FILTER DEVICE CLEANING METHOD

(71) Applicant: MITSUBISHI HEAVY INDUSTRIES, LTD., Tokyo (JP)

(72) Inventor: Katsunori Matsui, Tokyo (JP)

(73) Assignee: MITSUBISHI HEAVY INDUSTRIES, LTD., Tokyo (JP)

(21) Appl. No.: 15/112,582

(22) PCT Filed: Jan. 30, 2015
(86) PCT No.: PCT/JP2015/052643

§ 371 Date: Jul. 19, 2016

(30) Foreign Application Priority Data
Jan. 31, 2014 (JP) 2014-016963

(51) Int. Cl. C02F 3/00; C02F 3/08; C02F 9/00; C02F 3/06

(52) U.S. Cl. CPC C02F 3/006; C02F 3/06; C02F 3/085; C02F 9/00; C02F 2303/16; C02F 2209/40; C02F 2103/08

(57) ABSTRACT

A biofilm filter device in which a biofilm formed on a filter medium layer removes impurities mixed in a target liquid flowing from an upstream side so as to discharge a filtered liquid from a downstream side. The biofilm filter device includes a wash water supply unit that supplies wash water from the downstream side of the filter medium layer, and a control unit that controls a flow speed of the wash water supplied by the wash water supply unit. After the control unit supplies the wash water at a first flow speed which fluidizes only a prescribed range layer on the upstream side of the filter medium layer, the control unit supplies the wash water at a second flow speed which does not fluidize the whole filter medium layer.

### TECHNICAL FIELD

The present invention relates to a biofilm filter device, a desalination system, and a cleaning method of the biofilm filter device.

Priority is claimed on Japanese Patent Application No. 2014-016963, filed Jan. 31, 2014, the content of which is incorporated herein by reference.

### BACKGROUND ART

A filter device in the related art includes a biofilm filter device in which a biofilm formed on a filter medium layer (sand layer) filled with a filter medium such as sand removes impurities mixed into raw water (target liquid), such as seawater and waste water, flowing from an upstream side so as to discharge the target liquid from a downstream side as a filtered liquid.

In this type of the biofilm filter device, for example, as disclosed in a Patent Literature 1, it is necessary to remove the impurities adhering to the biofilm by performing a back cleaning process for causing wash water to flow from the downstream side to the upstream side of the filter medium layer after a predetermined operation time (filtering time) elapses.

A Patent Literature 2 discloses a biofilm filter device in which an inlet port for wash water is disposed in an intermediate portion between an upstream side and a downstream side in a filter medium layer (filler filled layer) so as to suitably clean and remove only a large amount of floating substances (impurities) deposited in an upstream side portion (surface layer portion) in a back cleaning process.

### CITATION LIST

### Patent Literature

[Patent Literature 1] Japanese Unexamined Patent Application, First Publication No. H9-215986

[Patent Literature 2] Japanese Unexamined Patent Application, First Publication No. H8-252590

### SUMMARY OF INVENTION

### Technical Problem

However, according to the biofilm filter device disclosed in the Patent Literature 1, wash water supplied to a filter medium layer during cleaning has a single (constant) flow speed. Consequently, there is a possibility that a filtering function using the filter medium layer may decrease or a cleaning time may be lengthened due to the cleaning. For example, if the flow speed is slow to such an extent that the whole filter medium layer is not fluidized, the cleaning time is lengthened in an upstream side range of the filter medium layer which particularly has a lot of impurities, thereby lengthening a time required for restarting filtration of a target liquid. In addition, for example, if the flow speed is fast to such an extent that the whole filter medium layer is fluidized, a biofilm formed on a surface of a filter medium is separated therefrom, thereby impairing the filtering function using the filter medium layer. As a result, the time required for restarting the filtration of the target liquid is lengthened.

According to the biofilm filter device disclosed in the Patent Literature 2, only an upstream side range in the filter medium layer is cleaned. Accordingly, even if the flow speed of the wash water is fast, the biofilm is not separated in a downstream side range of the filter medium layer. However, since the downstream side range is not cleaned, the filtering function using the filter medium layer decreases.

The present invention is made in view of the above-described circumstances, and an object thereof is to provide a biofilm filter device, a desalination system including the same, and a cleaning method of the biofilm filter device, which can quickly and efficiently cleaning a filter medium layer while preventing a filtering function from being degraded.

### Solution to Problem

(1) According to an aspect of the present invention, there is provided a biofilm filter device in which a biofilm formed on a filter medium layer removes impurities mixed in a target liquid flowing from an upstream side so as to discharge a filtered liquid from a downstream side. The biofilm filter device includes a wash water supply unit that supplies wash water from the downstream side of the filter medium layer, and a control unit that controls a flow speed of the wash water supplied by the wash water supply unit. After the control unit supplies the wash water at a first flow speed which fluidizes only a prescribed range layer on the upstream side of the filter medium layer, the control unit supplies the wash water at a second flow speed which does not fluidize the whole filter medium layer.

(2) According to another aspect of the present invention, there is provided a cleaning method of a biofilm filter device for cleaning a filter medium layer by supplying wash water from a downstream side of the filter medium layer for the biofilm filter device in which a biofilm formed on the filter medium layer removes impurities mixed in a target liquid flowing from an upstream side so as to discharge a filtered liquid from the downstream side. The cleaning method includes a first cleaning process of supplying the wash water at a first flow speed which fluidizes only a prescribed range layer on the upstream side of the filter medium layer, and a second cleaning process of supplying the wash water at a second flow speed which does not fluidize the whole filter medium layer after the first cleaning process.

According to the above-described biofilm filter device and cleaning method, when the filter medium layer is cleaned, first, an upstream side range (prescribed range layer on the upstream side) of the filter medium layer which has a lot of impurities adhering to the biofilm is positively fluidized. Accordingly, the impurities in the upstream side range of the filter medium layer can be quickly and efficiently removed. On the other hand, even if the wash water is supplied to the filter medium layer at the first flow speed, the downstream side range of the filter medium layer is not fluidized. However, thereafter, by continuously supplying the wash water at the second flow speed, the impurities in the downstream side range of the filter medium layer can also be sufficiently removed.

Furthermore, according to the above-described biofilm filter device and cleaning method, the upstream side range within the filter medium layer is limitedly fluidized by the wash water. Accordingly, the biofilm is separated from only a prescribed range layer on the upstream side of the filter medium layer due to the cleaning, and the biofilm in the downstream side range of the filter medium layer remains as it is. Therefore, even if the cleaning is performed, a filtering function of the biofilm filter device can be maintained. Even immediately after the cleaning, the target liquid can be filtered.

For the above-described reason, according to the above-described biofilm filter device and cleaning method, compared with a case where the wash water is supplied at a single flow speed, the impurities adhering to the biofilm of the filter medium layer can be efficiently removed while the filtering function is prevented from being degraded.

(3) In the biofilm filter device described in (1), the biofilm filter device further includes a detection unit that detects turbidity of an effluent flowing from the upstream side of the filter medium layer of the wash water supplied by the wash water supply unit. The control unit switches the flow speeds of the wash water, based on a turbidity detection result of the detection unit.

In this case, in accordance with the turbidity of the effluent, the flow speed of the wash water to be supplied to the filter medium layer can be suitably switched from the first flow speed to the second flow speed. Accordingly, the impurities adhering to the biofilm of the filter medium layer can be more sufficiently removed.

(4) In the biofilm filter device described in (1) or (3), the filter medium layer is divided into multiple layers in a direction from the upstream side toward the downstream side. At least one of a particle size and a specific gravity of a filter medium on the uppermost layer located on the uppermost stream in the multiple layers is set to be smaller than that of the filter medium on the other layers located on the downstream side of the uppermost layer. The first flow speed controlled by the control unit is the flow speed which fluidizes only the uppermost layer.

In this case, due to the flow of the wash water, the uppermost layer is more likely to be fluidized than the other layers. Accordingly, the first flow speed is easily set. That is, only the uppermost layer can suitably and simply be fluidized. Therefore, it is possible to shorten a cleaning time.

Furthermore, since the uppermost layer is more likely to be fluidized than the other layers, the first flow speed can be reduced to a lower level. In this manner, even if the cleaning is performed, the biofilm more readily remains as it is in the filter medium layer. It is possible to reduce the amount of the wash water used for the cleaning.

(5) In the biofilm filter device described in any one of (1), (3), and (4), the filter medium layer is divided into multiple layers in a direction from the upstream side toward the downstream side. The biofilm filter device further includes a mixing inhibitor that is disposed between the uppermost layer located on the uppermost side in the multiple layers and the other layers adjacent to the downstream side of the uppermost layer, and that inhibits the uppermost layer and the other layers from mixing with each other.

In this case, the uppermost layer and the other layers are prevented from mixing with each other. Accordingly, only the uppermost layer is reliably fluidized by supplying the wash water at the first flow speed. In this manner, it is possible to reliably prevent the other layers from being fluidized.

(6) According to another aspect of the present invention, there is provided a desalination system including the biofilm filter device according to any one of (1) and (3) to (5), and a desalination device that desalinates the filtered liquid discharged from the biofilm filter device.

### Advantageous Effects of Invention

According to the present invention, impurities adhering to a biofilm of a filter medium layer can be efficiently removed while a filtering function of a biofilm filter device is prevented from being degraded.

### BRIEF DESCRIPTION OF DRAWINGS

FIG. 1 is a view illustrating an example of a desalination system which employs a biofilm filter device and a cleaning method of the biofilm filter device according to a first embodiment of the present invention.

FIG. 2 is a view illustrating a filtering process, and first and second cleaning processes which are performed in the biofilm filter device illustrated in FIG. 1.

FIG. 3 is a view illustrating a relationship between a cleaning time and turbidity in the first and second cleaning processes which are performed in the biofilm filter device illustrated in FIG. 1.

FIG. 4 is a view illustrating a biofilm filter device according to a second embodiment of the present invention.

FIG. 5 is a view illustrating a relationship between a flow speed and a cleaning effect around a filter medium layer in a cleaning method performed in the biofilm filter device illustrated in FIG. 4.

FIG. 6 is a view illustrating a biofilm filter device according to a third embodiment of the present invention.

### DESCRIPTION OF EMBODIMENTS

### First Embodiment

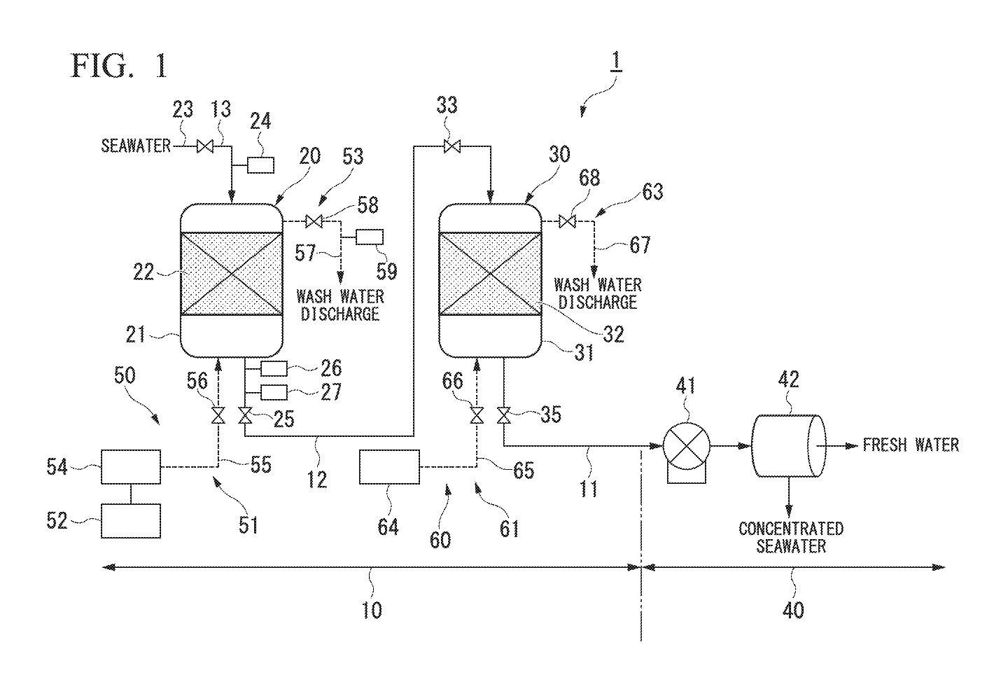

Hereinafter, a first embodiment according to the present invention will be described with reference to FIGS. 1 to 3.

A biofilm filter device according to the present embodiment is applied to a desalination system 1 illustrated in FIG. 1. The desalination system 1 desalinates raw water (target liquid) such as seawater and waste water. The desalination system 1 includes a purifier 10 that performs desalination pretreatment (hereinafter, referred to as “pretreatment”) on the seawater, and a desalination device 40 that desalinates the seawater subjected to the pretreatment (secondarily pretreated seawater to be described later). The purifier 10 and the desalination device 40 are connected to each other by a connection pipe 11.

Hereinafter, an example will be described in which the seawater is treated as the raw water (target liquid).

The purifier 10 includes two biofilm filter devices 20 and 30 so as to perform the pretreatment on the seawater in two stages. The two biofilm filter devices 20 and 30 are connected to each other in series by a connection pipe 12.

In the purifier 10, the seawater is first guided to the primary biofilm filter device 20 (hereinafter, referred to as a “primary filter device 20”). In the primary filter device 20, the pretreatment in the first stage (primary pretreatment) is performed, and the seawater becomes primarily pretreated seawater (filtered liquid). The primarily pretreated seawater is guided to the secondary biofilm filter device 30 (hereinafter, referred to as a “secondary filter device 30”) through the connection pipe 12. The primarily pretreated seawater (target liquid) guided to the secondary filter device 30 becomes the secondarily pretreated seawater (filtered liquid) subjected to the pretreatment (secondary pretreatment) in the second stage. The secondarily pretreated seawater is supplied to the desalination device 40 through the connection pipe 11. Therefore, impurities such as turbid components (contaminants such as sand or mud) mixed in the seawater are further removed in the primary filter device 20, compared with the secondary filter device 30.

A filtering treatment direction of the seawater in the biofilm filter devices 20 and 30 according to the present embodiment is a vertically downward direction as illustrated in FIG. 1. However, without being limited thereto, for example, the direction may be an obliquely downward direction with respect to the vertical direction or a horizontal direction.

The seawater purified in the primary filter device 20 and the secondary filter device 30 is supplied from the purifier 10 to the desalination device 40 by the connection pipe 11. The desalination device 40 includes a pump 41 that introduces the purified seawater (secondarily pretreated seawater), and a reverse osmosis membrane 42 that separates the seawater into fresh water and concentrated seawater.

The primary filter device 20 performs chemical-free pretreatment by forming a filter medium layer 22 in which the filter vessel 21 (filter tower) is internally filled with a granular filter medium such as sand, and by forming a biofilm on a surface of the filter medium which forms the filter medium layer 22. The filter medium layer 22 according to the present embodiment is installed in an intermediate portion of the filter vessel 21 by leaving a suitable space portion on the upstream side and the downstream side. A particle size or a specific gravity of the filter medium which forms the filter medium layer 22 according to the present embodiment is set to be, for example, substantially uniform.

A raw water pipe 13 is connected to an upper portion (upstream side portion) of the filter vessel 21. The seawater is introduced into the upper portion of the filter vessel 21 from the raw water pipe 13. An on-off valve (first on-off valve) 23 for opening and closing the raw water pipe 13 is disposed in the raw water pipe 13. In addition, an upstream side pressure detection unit 24 which detects pressure of the seawater flowing in the raw water pipe 13 is disposed in the vicinity of the filter vessel 21 in the raw water pipe 13.

Furthermore, the above-described connection pipe 12 is connected to a lower portion (downstream side portion) of the filter vessel 21. An on-off valve (second on-off valve) 25 for opening and closing the connection pipe 12 is disposed in the vicinity of the filter vessel 21 in the connection pipe 12. In addition, a downstream side pressure detection unit 26 which detects pressure of the primarily pretreated seawater discharged from the filter vessel 21 and flowing in the connection pipe 12 and a treated water turbidity detection unit 27 which detects turbidity of the primarily pretreated seawater are disposed in the vicinity of the filter vessel 21 in the connection pipe 12.

Then, the primary filter device 20 includes a back cleaning mechanism 50 that removes the impurities adhering to the biofilm of the filter medium layer 22. The back cleaning mechanism 50 includes a wash water supply unit 51 that supplies the wash water from the downstream side of the filter medium layer 22, and a flow speed control unit (control unit) 52 that controls a flow speed of the wash water to be supplied by the wash water supply unit 51. In addition, the back cleaning mechanism 50 includes a wash water discharge unit 53 that discharges the wash water (effluent) passing through the filter medium layer 22 from the upstream side.

The wash water supply unit 51 includes a supply unit main facility 54 that includes a supply source of the wash water or a pump, and a wash water supply pipe 55 that connects the supply unit main facility 54 and the lower portion of the filter vessel 21 to each other. An on-off valve (third on-off valve) 56 for opening and closing a cleaning supply pipe is disposed in the vicinity of the lower portion of the filter vessel 21 in the wash water supply pipe.

A wash water discharge unit 53 includes a wash water discharge pipe 57 which is connected to the upper portion of the filter vessel 21 located above (upstream side) the filter medium layer 22. An on-off valve (fourth on-off valve) 58 for opening and closing the wash water discharge pipe 57 is disposed in the wash water discharge pipe 57. In addition, a wash water turbidity detection unit (detection unit) 59 which detects turbidity of the wash water (effluent) discharged from the filter vessel 21 is disposed in the vicinity of the filter vessel 21 in the wash water discharge pipe 57. The wash water turbidity detection unit 59 may be individually installed with the treated water turbidity detection unit 27 as in the illustrated example. For example, in order to also function as the treated water turbidity detection unit 27, the wash water turbidity detection unit 59 may be connected to both the connection pipe 12 and the wash water discharge pipe 57. The wash water turbidity detection unit 59 may be operated by a switching valve so as to selectively detect the turbidity of the primarily pretreated seawater discharged from the filter vessel 21 and the turbidity of the wash water (effluent) discharged from the filter vessel 21.

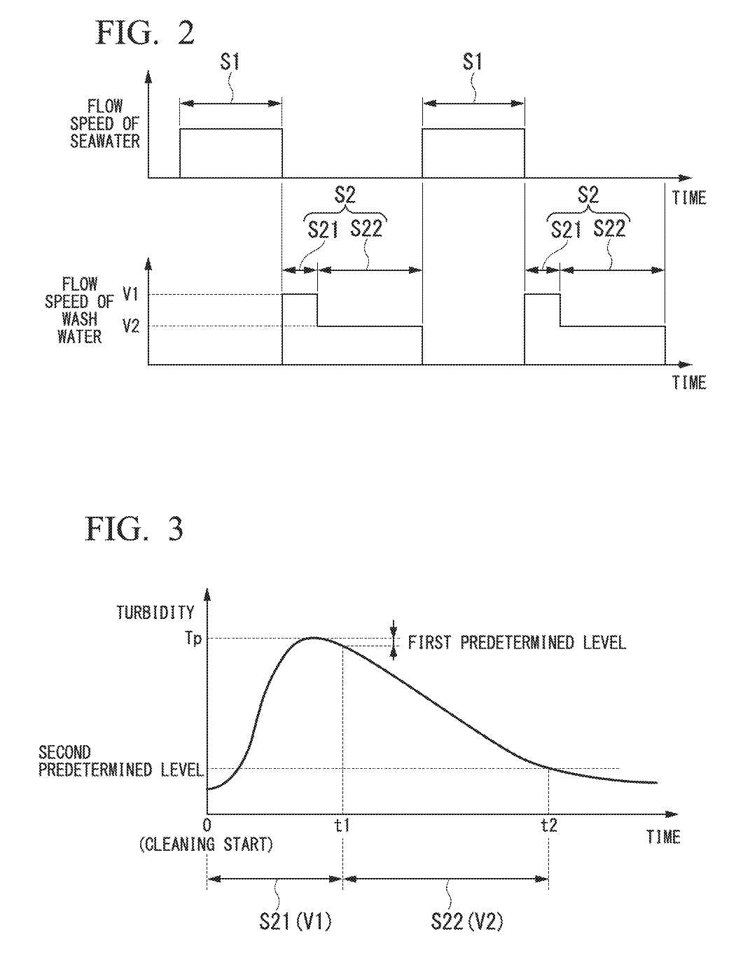

As illustrated in FIGS. 1 and 2, after a flow speed control unit 52 supplies the wash water at a first flow speed V1 which fluidizes only a prescribed range layer on the upstream side of the filter medium layer 22, the flow speed control unit 52 supplies the wash water at a second flow speed V2 which does not fluidize the whole filter medium layer 22. Here, the prescribed range on the upstream side is a range where many impurities such as turbid components adhere to the biofilm (for example, a range from an upper surface (upstream side end surface) of the filter medium layer 22 to a position moved toward the downstream side of the filter medium layer 22 as far as several percentages to several tens percentages of the entire height of the filter medium layer 22 (the entire height is defined as the range from the upper surface to the lower surface (downstream side end surface) of the filter medium layer 22.)). The prescribed range on the upstream side is selected depending on states such as the turbidity, temperature, and salinity of the raw water, or filtering capacity of the filter medium layer 22. Both the first flow speed V1 and the second flow speed V2 are determined to such an extent that a predetermined advantageous cleaning effect can be obtained (the impurities can be effectively removed from the filter medium layer 22), and are obtained by “Expression 1” below. The second flow speed V2 is slower than the first flow speed V1. For example, the first flow speed V1 which fluidizes only the upstream side portion of the filter medium layer 22 is set in view of the fact that a load applied to the downstream side portion of the filter medium layer 22 is heavier than a load applied to the upstream side portion.

V=0.139ds^{3/2}(1+0.06es)(9t+310)cs^{3/2} [Expression 1]

V=back cleaning speed (cm/min)

t=water temperature (° C.)

ds=effective size of sand (m/m)

es=expansion rate of sand (%)

cs=uniformity coefficient of sand

This expression is cited from “No. 9, Vol. 5, Water Treatment Technology Written by Osamu Shinohara, 1964”.

With regard to the above-described first flow speed V1, in order to confirm whether only the prescribed range layer on the upstream side of the filter medium layer 22 is fluidized, the primary biofilm filter device 20 is produced for trial, and a back cleaning test is performed. In addition, in a case where a result of the back cleaning test shows that a fluidized range is sufficient or insufficient, the flow speed may be adjusted so that only the prescribed range layer on the upstream side is fluidized.

Based on the detection result of the turbidity detected in the above-described wash water turbidity detection unit 59, the flow speed control unit 52 switches the flow speed of the wash water from the first flow speed V1 to the second flow speed V2. According to the present embodiment, in a state where the wash water is supplied to the filter medium layer 22 at the first flow speed V1, after the turbidity detected in the wash water turbidity detection unit 59 reaches the maximum value Tp as illustrated in FIG. 3, and when the turbidity is lowered from the maximum value Tp as much as a predetermined level (first predetermined level), the flow speed control unit 52 switches the flow speed of the wash water from the first flow speed V1 to the second flow speed V2. The above-described flow speed control unit 52 may change the flow speed of the wash water, for example, by adjusting an output of a pump of the supply unit main facility 54, or for example, by adjusting an opening degree of the fourth on-off valve 58 (flow rate adjusting valve).

Furthermore, the primary filter device 20 includes a switching control unit (not illustrated) which switches between a state where the seawater is supplied to the filter vessel 21 and a state where the wash water is supplied to the filter vessel 21. The switching control unit according to the present embodiment switches from the state where the seawater is supplied to the filter vessel to the state where the wash water is supplied to the filter vessel, based on the detection result of the upstream side pressure detection unit 24 and the downstream side pressure detection unit 26 and the detection result of the treated water turbidity detection unit 27.

For example, in the state where the seawater is supplied to the filter vessel 21, in a case where the pressure detection result of the upstream side pressure detection unit 24 is equal to or greater than a predetermined value, compared with the pressure detection result of the downstream side pressure detection unit 26 (in a case where a pressure difference is equal to or greater than the predetermined value), the switching control unit determines that the filter medium layer 22 is clogged. The switching control unit stop supplying the seawater to the filter vessel 21 by closing the first and second on-off valves 23 and 25, and starts to supply the wash water to the filter vessel 21 by opening the third and fourth on-off valves 56 and 58. In addition, for example, in the state where the seawater is supplied to the filter vessel 21, in a case where the turbidity detection result of the treated water turbidity detection unit 27 is equal to or higher than a predetermined level, the switching control unit determines that the filtering function using the filter medium layer 22 is degraded. Similarly to the above-described configuration, the switching control unit stops supplying the seawater to the filter vessel 21, and starts to supply the wash water to the filter vessel 21.

On the other hand, in the state where the wash water is supplied to the filter vessel 21, in a case where the turbidity detection result of the wash water turbidity detection unit 59 is equal to or lower than a predetermined level (second predetermined level in FIG. 3), the switching control unit determines that the filtering function of the filter medium layer 22 is recovered. The switching control unit stops supplying the wash water to the filter vessel 21 by closing the third and fourth on-off valves 56 and 58, and starts to supply the seawater to the filter vessel 21 by opening the first and second on-off valves 23 and 25.

Similarly to the primary filter device 20, the secondary filter device 30 performs chemical-free pretreatment by forming a filter medium layer 32 in which the filter vessel 31 is internally filled with sand, and by forming the biofilm on the surface of the filter medium of the filter medium layer 32.

That is, the connection pipe 12 is connected to the upper portion (upstream side portion) of the filter vessel 31.

An on-off valve (fifth on-off valve) 33 for opening and closing the connection pipe 12 is disposed in the vicinity of the filter vessel 31 in the connection pipe 12. Furthermore, for example, similarly to the upstream side pressure detection unit 24 of the primary filter device 20, a pressure detection unit (not illustrated) which detects the pressure of the primarily pretreated seawater flowing in the connection pipe 12 may be disposed in the vicinity of the filter vessel 31 in the connection pipe 12. In addition, the above-described connection pipe 11 is connected to the lower portion (downstream side portion) of the filter vessel 31. An on-off valve (sixth on-off valve) 35 for opening and closing the connection pipe 11 is disposed in the vicinity of the filter vessel 31 in the connection pipe 11. Furthermore, for example, a pressure detection unit (not illustrated) or a turbidity detection unit (not illustrated) which is similar to the downstream side pressure detection unit 26 or the treated water turbidity detection unit 27 of the primary filter device 20 may be disposed in the vicinity of the filter vessel 31 in the connection pipe 11.

In addition, similarly to the primary filter device 20, the secondary filter device 30 includes a back cleaning mechanism 60 for removing the impurities adhering to the biofilm of the filter medium layer 32. The back cleaning mechanism 60 of the secondary filter device 30 includes a wash water supply unit 61 and a wash water discharge unit 63 which are similar to those in the primary filter device 20.

The wash water supply unit 61 includes a supply unit main facility 64 that includes a supply source of the wash water or a pump, and a wash water supply pipe 65 that connects the supply unit main facility 64 and the lower portion of the filter vessel 31 to each other. The flow speed of the wash water supplied from the supply unit main facility 64 to the filter medium layer 32 is constant and is set to be a flow speed which does not fluidize the whole filter medium layer 32. An on-off valve (seventh on-off valve) 66 for opening and closing the wash water supply pipe 65 is disposed in the wash water supply pipe 65.

Similarly to the primary filter device 20, the wash water discharge unit 63 includes a wash water discharge pipe 67 which is connected to the upper portion of the filter vessel 31 located above (upstream side) the filter medium layer 32. An on-off valve (eighth on-off valve) 68 for opening and closing the wash water discharge pipe 67 is disposed in the wash water discharge pipe 67. In addition, for example, a turbidity detection unit (not illustrated) which is similar to the wash water turbidity detection unit 59 of the primary filter device 20 may be disposed in the vicinity of the filter vessel 21 in the wash water discharge pipe 67.

In addition, the secondary filter device 30 also includes a switching control unit (not illustrated) which is similar to that of the primary filter device 20.

Next, an operation of the purifier 10 in the desalination system 1 according to the present embodiment configured as described above, particularly, a cleaning method of the primary filter device 20 will be described.

In the purifier 10, the seawater is caused to sequentially pass through the primary filter device 20 and the secondary filter device 30, thereby removing the impurities such as turbid components contained in the seawater (filtering process S1, refer to FIG. 2). In the filtering process S1, the impurities adhere to the biofilm formed on the filter medium layers 22 and 32 of the respective filter devices 20 and 30 so as to be removed from the seawater. The impurities in the seawater are further removed in the upstream side range (prescribed range layer on the upstream side), compared with the downstream side range of the filter medium layers 22 and 32. In addition, in the filtering process S1, a switching control unit (not illustrated) of the filter devices 20 and 30 monitors the detection result of the upstream side pressure detection unit 24 and the downstream side pressure detection unit 26 or the detection result of the treated water turbidity detection unit 27.

During the above-described filtering process S1, for example, in the primary filter device, in a case where the pressure detection result of the upstream side pressure detection unit 24 is equal to or greater than a predetermined value, compared with the pressure detection result of the downstream side pressure detection unit 26, or in a case where the turbidity detection result of the treated water turbidity detection unit 27 is equal to or higher than a predetermined level, the switching control unit stops supplying the seawater to the filter vessel 21 by closing the first and second on-off valves 23 and 25, and starts to supply the wash water to the filter vessel 21 by opening the third and fourth on-off valves 56 and 58. In this manner, the wash water is supplied from the downstream side of the filter medium layer 22 so as to start a cleaning process S2 (refer to FIG. 2) of cleaning the filter medium layer 22. In the cleaning process S2 (cleaning method), a first cleaning process S21 and a second cleaning process S22 (refer to FIG. 2) are sequentially performed, thereby removing the impurities adhering to the biofilm of the filter medium layer 22 from the filter medium layer 22.

In the first cleaning process S21, the wash water is supplied at the first flow speed V1 which fluidizes only the prescribed range layer on the upstream side of the filter medium layer 22. According to the present embodiment, the flow speed control unit 52 controls the flow speed of the wash water so as to be the first flow speed V1. In the first cleaning process S21, the upstream side range of the filter medium layer 22 which has many impurities adhering to the biofilm is positively fluidized. Accordingly, the impurities in the upstream side range of the filter medium layer 22 are quickly and efficiently removed. In addition, in the first cleaning process S21, the downstream side range of the filter medium layer 22 which has a few impurities adhering to the biofilm is not fluidized. The impurities in the downstream side range of the filter medium layer 22 are removed little by little.

Then, in a state of containing the removed impurities, the wash water (effluent) passing through the filter medium layer 22 at the first flow speed V1 is discharged from the upstream side of the filter medium layer 22 to the wash water discharge pipe 57. Therefore, in the first cleaning process S21, as illustrated in FIG. 3, the impurities contained in the effluent increase with the lapse of time, and the turbidity of the effluent becomes higher. Then, the turbidity of the effluent reaches the maximum value Tp, and thereafter, the turbidity starts to be lowered.

In the cleaning method according to the present embodiment, the turbidity of the effluent is detected (detection process). The detection process according to the present embodiment is performed by the wash water turbidity detection unit 59. In addition, in the cleaning method according to the present embodiment, based on the turbidity detection result in the detection process, the above-described first cleaning process S21 is switched to the second cleaning process S22 (switching process, to be described later). The switching process according to the present embodiment is performed by the flow speed control unit 52.

In the switching process according to the present embodiment, as illustrated in FIGS. 2 and 3, when the turbidity is lowered from the maximum value Tp as much as the first predetermined level, the flow speed control unit 52 switches the flow speed of the wash water from the first flow speed V1 to the second flow speed V2. In this manner, the second cleaning process S22 is performed in which the wash water is supplied at the second flow speed V2 which does not fluidize the whole filter medium layer 22.

In the second cleaning process S22, the flow speed of the wash water passing through the filter medium layer 22 is slower than that in the first cleaning process S21. Accordingly, the impurities are less efficiently removed from the filter medium layer 22, compared with the first cleaning process S21. However, since the wash water flows in the entire filter medium layer 22, the impurities are removed from the filter medium layer 22 little by little. In this manner, in the second cleaning process S22, as illustrated in FIG. 3, the turbidity of the effluent is slowly lowered with the lapse of time.

Then, when the turbidity of the effluent is equal to or lower than the second predetermined level, the second cleaning process S22 is stopped as illustrated in FIG. 2, and the above-described filtering process S1 restarts. According to the present embodiment, the second cleaning process S22 is switched to the filtering process S1 by the switching control unit. The filtering process S1, the first cleaning process S21, and the second cleaning process S22 are repeatedly and sequentially performed.

The cleaning method of the secondary filter device 30 can be performed similarly to the cleaning method of the primary filter device except for the above-described first cleaning process S21 and switching process, and thus, description thereof will be omitted.

As described above, according to the present embodiment, when the filter medium layer 22 of the primary filter device 20 is cleaned, the upstream side range of the filter medium layer 22 which has many impurities adhering to the biofilm is first positively fluidized. Accordingly, the impurities in the upstream side range of the filter medium layer 22 can be quickly and efficiently removed. On the other hand, even if the wash water is supplied to the filter medium layer at the first flow speed V1, the downstream side range of the filter medium layer 22 is not fluidized. However, thereafter, if the wash water continues to be supplied at the second flow speed V2, the impurities in the downstream side range of the filter medium layer 22 can also be sufficiently removed. Therefore, it is possible to prevent water quality of the filtered liquid (secondarily pretreated seawater or fresh water) from being deteriorated in treatment facilities (the secondary filter device 30 and the desalination device 40) which perform treatment on the primarily pretreated seawater discharged from the primary filter device 20.

In addition, according to the present embodiment, the upstream side range within the filter medium layer 22 is limitedly fluidized by the wash water. Accordingly, the biofilm is separated from only the prescribed range layer on the upstream side of the filter medium layer 22 due to the cleaning, and the biofilm in the downstream side range of the filter medium layer 22 is maintained. Furthermore, the upstream side range of the filter medium layer 22 is located on an inlet port side into which the seawater flows. Accordingly, it is possible to quickly recover the biofilm in the upstream side range of the filter medium layer 22 by restarting the filtering process S1. Therefore, even if the cleaning is performed, a filtering function of the primary filter device 20 can be maintained. Even immediately after the cleaning, the seawater can be filtered.

For the above-described reason, according to the present embodiment, compared with a case where the wash water is supplied at a single flow speed, the impurities adhering to the biofilm of the filter medium layer 22 can be efficiently removed while the filtering function of the primary filter device 20 is prevented from being degraded.

In addition, according to the present embodiment, the second flow speed V2 of the wash water in the second cleaning process S22 is slower than the first flow speed V1 of the wash water in the first cleaning process S21. Accordingly, compared with a case where the wash water is supplied at a single flow speed, it is possible to reduce the amount of the used wash water.

Furthermore, according to the present embodiment, in accordance with the turbidity of the effluent discharged from the upstream side of the filter medium layer 22, the flow speed of the wash water to be supplied to the filter medium layer 22 can be suitably switched from the first flow speed V1 to the second flow speed V2. Accordingly, the impurities adhering to the biofilm of the filter medium layer 22 can be more efficiently removed.

### Second Embodiment

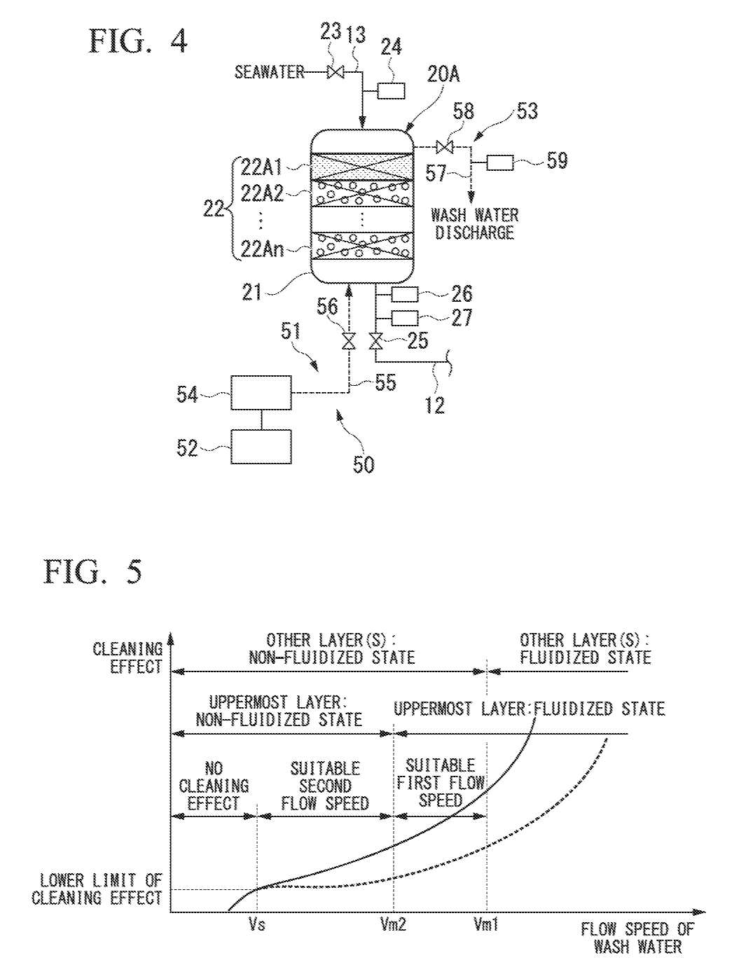

Next, with regard to a second embodiment according to the present invention, points different from those according to the first embodiment will be mainly described with reference to FIGS. 4 and 5. The same reference numerals will be given to configurations common to those according to the first embodiment, and description thereof will be omitted.

As illustrated in FIG. 4, a primary filter device 20A according to the present embodiment is disposed in the desalination system 1 (refer to FIG. 1) instead of the primary filter device 20 according to the first embodiment.

The primary filter device 20A according to the present embodiment includes the filter vessel 21, the filter medium layer 22, and the back cleaning mechanism 50 which are similar to those according to the first embodiment. However, the filter medium layer 22 according to the present embodiment is divided into multiple layers 22A1 to 22An in a direction from the upstream side toward the downstream side. The filter medium layer 22 in the illustrated example is divided into the n-number (n=2, 3, 4, . . . ) of layers 22A1 to 22An. At least one of a particle size and a specific gravity of the filter medium forming the uppermost layer 22A1 located on the uppermost stream in the multiple layers 22A1 to 22An is set to be smaller than that of the other layers 22A2 to 22An located on the downstream side of the uppermost layer 22A1. The filter medium of the other layers 22A2 to 22An may have mutually different particle sizes or specific gravities, or may have the same particle size or specific gravity. For example, the particle size or the specific gravity of the filter medium in the other layers 22A2 to 22An may be set to be equal or become greater toward the downstream side of the filter medium layer 22.

Then, according to the present embodiment, the first flow speed V1 (refer to FIG. 2) is set by the flow speed control unit 52 so as to fluidize only the uppermost layer 22A1. In contrast, the suitable first flow speed V1 can be easily set by setting the particle size and the specific gravity of the filter medium in the uppermost layer 22A1 as described above. Hereinafter, details will be described with reference to FIG. 5.

In a graph in FIG. 5, the horizontal axis represents the flow speed of the wash water, and the vertical axis represents a cleaning effect (back cleaning effect) corresponding to the flow speed of the wash water. If a numerical value of the cleaning effect increases, the increased numerical value indicates that the filter medium layer 22 is efficiently cleaned. In addition, a “lower limit of the cleaning effect” represents a boundary to determine whether or not an advantageous cleaning effect can be obtained in the primary filter device 20A.

Characteristics of the cleaning effect are uniquely determined in accordance with the particle size or the specific gravity of the filter medium configuring the filter medium layer 22.

That is, a relationship between the flow speed of the wash water and the cleaning effect in a case of the uppermost layer 22A1 is determined as illustrated by a solid line of the graph in FIG. 5. In addition, a relationship between the flow speed of the wash water and the cleaning effect in a case of the other layers 22A2 to 22An is determined as illustrated by a dash line of the same graph.

In addition, since the graph in FIG. 5 can be obtained, it is possible to easily obtain a flow speed (boundary flow speed Vm2 of the uppermost layer 22A1) of the wash water corresponding to a boundary between a fluidized state and a non-fluidized state of the uppermost layer 22A1, a flow speed (boundary flow speed Vm1 of the other layers 22A2 to 22An) of the wash water corresponding to a boundary between a fluidized state and a non-fluidized state of the other layers, and a flow speed (lower limit flow speed Vs) of the wash water corresponding to the “lower limit of the cleaning effect”. The particle size or the specific gravity of the other layers 22A2 to 22An is greater than that of the uppermost layer 22A1. Accordingly, the boundary flow speed Vm1 of the other layers 22A2 to 22An is faster than the boundary flow speed Vm2 of the uppermost layer 22A1.

Therefore, the suitable first flow speed V1 of the wash water may be set in a range from the boundary flow speed Vm2 of the uppermost layer 22A1 to the boundary flow speed Vm1 of the other layers 22A2 to 22An. In addition, the suitable second flow speed V2 (refer to FIG. 2) of the wash water may be set in a range from the lower limit flow speed Vs and slower than the boundary flow speed Vm2 of the uppermost layer 22A1.

According to the primary filter device 20A of the present embodiment, the same advantageous effect as that according to the first embodiment is achieved.

In addition, due to the flow of the wash water, the uppermost layer 22A1 is more likely to be fluidized than the other layers 22A2 to 22An. Accordingly, the first flow speed V1 is easily set. That is, only the uppermost layer 22A1 can be suitably and simply fluidized. Therefore, it is possible to shorten a cleaning time. In addition, since the uppermost layer 22A1 is more likely to be fluidized than the other layers 22A2 to 22An, the first flow speed V1 can be reduced to a lower level. In this manner, even if the filter medium layer 22 is cleaned, the biofilm is more easily maintained in the filter medium layer 22. It is possible to reduce the amount of the wash water used for the cleaning.

### Third Embodiment

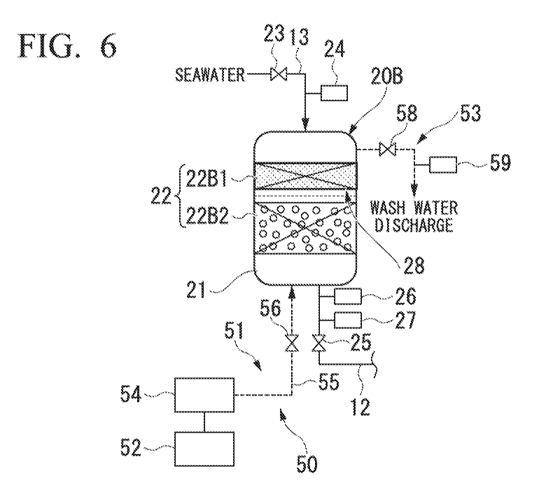

Next, with regard to a third embodiment according to the present invention, points different from those according to the first embodiment will be mainly described with reference to FIG. 6. The same reference numerals will be given to configurations common to those according to the first embodiment, and description thereof will be omitted.

As illustrated in FIG. 6, a primary filter device 20B according to the present embodiment is disposed in the desalination system 1 (refer to FIG. 1) instead of the primary filter device 20 according to the first embodiment. The primary filter device 20B according to the present embodiment includes the filter vessel 21, the filter medium layer 22, and the back cleaning mechanism 50 which are similar to those according to the first embodiment. However, the filter medium layer 22 according to the present embodiment is divided into multiple (two in the illustrated example) layers 22B1, and 22B2 in a direction from the upstream side toward the downstream side.

The particle size or the specific gravity of the filter medium forming the uppermost layer 22B1 located on the uppermost stream side in the multiple layers 22B1 and 22B2 may be set to be smaller than that of the other layer 2282, for example, similarly to a case according to the second embodiment. The filter medium forming the uppermost layer 22B1 may have the same particle size or the same specific gravity as the filter medium forming the other layer 22B2.

In addition, the primary filter device 20B according to the present embodiment includes a mixing inhibitor 28 disposed between the uppermost layer 22B1 and the other layer 22B2 adjacent on the downstream side. The mixing inhibitor 28 prevents the uppermost layer 22B1 and the other layer 22B2 from mixing with each other and is a net-like member through which the seawater or the filtered water passes.

According to the primary filter device 20B of the present embodiment, the same advantageous effect as that according to the first embodiment is achieved.

In addition, in order to prevent the uppermost layer 22B1 and the other layer 22B2 from mixing with each other, the wash water is supplied at the first flow speed V1 (refer to FIG. 2). In this manner, only the uppermost layer 22B1 is reliably fluidized, and thus, it is possible to reliably prevent the other layer 22B2 from being fluidized.

Hitherto, the present invention has been described in detail. However, without being limited to the above-described embodiments, the present invention can adopt various additional modifications within the scope not departing from the gist of the present invention.

For example, the flow speed control unit 52 according to the above-described embodiments switches the flow speeds of the wash water, based on the turbidity detection result of the wash water turbidity detection unit 59. However, for example, the filtering process S1 is switched to the cleaning process S2, and then, the flow speeds of the wash water may be automatically switched therebetween after a predetermined time elapses.

In addition, the flow speed control of the wash water which is performed by the flow speed control unit 52 is not limitedly applied to only the primary filter device 20, and may be applied to the secondary filter device 30, for example.

Furthermore, according to the above-described embodiments, the raw water is filtered using the two filter devices 20 and 30 in two stages. However, the number of biofilm filter devices configuring the purifier 10 is not particularly limited, and the raw water may be filtered in one stage or in three or more stages. In this case, it is desirable that the biofilm filter device and the cleaning method according to the present invention are applied to the first stage or those which are close to the first stage, but the configuration is not particularly limited.

In addition, without being limitedly applied to the desalination system 1, the biofilm filter device and the cleaning method according to the present invention can be applied to various systems which need to remove the impurities mixed in the raw water (target liquid).

### INDUSTRIAL APPLICABILITY

According to the present invention, impurities adhering to a biofilm of a filter medium layer can be efficiently removed while a filtering function of a biofilm filter device is prevented from being degraded.

### REFERENCE SIGNS LIST

1: DESALINATION SYSTEM,
20, 20A, 20B: PRIMARY BIOFILM FILTER DEVICE.
22: FILTER MEDIUM LAYER,
22A 1, 22B1: UPPERMOST LAYER.
22A2 to 22An, 22B2: OTHER LAYER(S),
28: MIXING INHIBITOR.
30: SECONDARY BIOFILM FILTER DEVICE.
40: DESALINATION DEVICE,
51: WASH WATER SUPPLY UNIT,
52: FLOW SPEED CONTROL UNIT (CONTROL UNIT),
59: WASH WATER TURBIDITY DETECTION UNIT (DETECTION UNIT),
S11: FIRST CLEANING PROCESS,
S22: SECOND CLEANING PROCESS,
V1: FIRST FLOW SPEED.
V2: SECOND FLOW SPEED

1. A biofilm filter device in which a biofilm formed on a filter medium layer removes impurities mixed in a target liquid flowing from an upstream side so as to discharge a filtered liquid from a downstream side, comprising:
a wash water supply unit that supplies wash water from the downstream side of the filter medium layer; and
a control unit that controls a flow speed of the wash water supplied by the wash water supply unit,
wherein after the control unit supplies the wash water at a first flow speed which fluidizes only a prescribed range layer which is in a range from an upper surface of the filter medium layer to a predetermined position on the upstream side of the filter medium layer with respect to the entire height of the filter medium layer, the control unit supplies the wash water at a second flow speed which does not fluidize the whole filter medium layer.

2. The biofilm filter device according to claim 1, further comprising:
a detection unit that detects turbidity of an effluent flowing from the upstream side of the filter medium layer of the wash water supplied by the wash water supply unit,
wherein the control unit switches the flow speeds of the wash water, based on a turbidity detection result using the detection unit.

3. The biofilm filter device according to claim 1,
wherein the filter medium layer is divided into multiple layers in a direction from the upstream side toward the downstream side,
wherein at least one of a particle size and a specific gravity of a filter medium on the uppermost layer located on the uppermost stream in the multiple layers is set to be smaller than that of the filter medium on the other layers located on the downstream side of the uppermost layer, and
wherein the first flow speed controlled by the control unit is the flow speed which fluidizes only the uppermost layer.

4. The biofilm filter device according to claim 1,
wherein the filter medium layer is divided into multiple layers in a direction from the upstream side toward the downstream side, and
wherein the biofilm filter device further comprises a mixing inhibitor that is disposed between the uppermost layer located on the uppermost side in the multiple layers and the other layers adjacent to the downstream side of the uppermost layer and that inhibits the uppermost layer and the other layers from mixing with each other.

5. A desalination system comprising:
the biofilm filter device according to claim 1; and
a desalination device that desalinates the filtered liquid discharged from the biofilm filter device.

6. A cleaning method of a biofilm filter device for cleaning a filter medium layer by supplying wash water from a downstream side of the filter medium layer for the biofilm filter device in which a biofilm formed on the filter medium layer removes impurities mixed in a target liquid flowing from an upstream side so as to discharge a filtered liquid from the downstream side, the method comprising:
a first cleaning process of supplying the wash water at a first flow speed which fluidizes only a prescribed range layer which is in a range from an upper surface of the filter medium layer to a predetermined position on the upstream side of the filter medium layer with respect to the entire height of the filter medium layer; and
a second cleaning process of supplying the wash water at a second flow speed which does not fluidize the whole filter medium layer after the first cleaning process.
